(19) United States
(12) Patent Application Publication
(10) Pub. No.: US 2019/0020027 A1
(43) Pub. Date: Jan. 17, 2019

(54) NEGATIVE ELECTRODE ACTIVE MATERIAL CONTAINING CARBON, BORON, AND CALCIUM, AND NITROGEN OR PHOSPHORUS, AND BATTERY

(71) Applicant: Panasonic Intellectual Property Management Co., Ltd., Osaka, CA (US)

(72) Inventors: GO TEI, Osaka (JP); RYOHEI MIYAMAE, Osaka (JP); AKIRA KANO, Osaka (JP)

(21) Appl. No.: 16/018,094

(22) Filed: Jun. 26, 2018

(30) Foreign Application Priority Data
Jul. 14, 2017 (JP) 2017-138138

(51) Int. Cl. H01M 4/58; H01M 4/36; H01M 10/0525; C01B 35/14

(52) U.S. Cl. CPC H01M 4/58; H01M 4/366; H01M 2004/027; C01B 35/146; H01M 10/0525

(57) ABSTRACT

A negative electrode active material includes a layered compound that includes: a plurality of layers and calcium located between the plurality of layers; each of the plurality of layers containing carbon and boron and further containing nitrogen or phosphorus.

### BACKGROUND

### 1. Technical Field

The present disclosure relates to a negative electrode active material and a battery.

### 2. Description of the Related Art

In lithium ion batteries in the related art, graphite is widely used as a negative electrode active material. As electric cars that use lithium ion batteries as power sources have spread rapidly, there has been an intense demand for an increased cruising distance of an electric car. In order to address this demand, it is important to increase the capacity of the negative electrode active material.

Japanese Unexamined Patent Application Publication No. 2002-110160 discloses a negative electrode active material that is denoted by composition formula AₓB_{y}C_{1-y} (A represents a metal element, and atomic ratios x and y satisfy 0.2≤x≤1 and 0.2≤y≤0.5, respectively) for a nonaqueous electrolyte secondary battery.

### SUMMARY

In one general aspect, the techniques disclosed here feature a negative electrode active material including a layered compound that includes: a plurality of layers; and calcium located between the plurality of layers, each of the plurality of layers containing carbon and boron and further containing nitrogen or phosphorus.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic sectional view of a battery according to an embodiment of the present disclosure;

FIG. 2 is a diagram showing XRD spectra of negative electrode active materials of example 1 and comparative examples 1 to 3;

FIG. 3A is a diagram showing a B1s XPS spectrum of the negative electrode active material of example 1; and

FIG. 3B is a diagram showing a N1s XPS spectrum of the negative electrode active material of example 1.

### DETAILED DESCRIPTION

Underlying Knowledge Forming Basis of Present Disclosure

The present inventors investigated in detail the negative electrode active material disclosed in Japanese Unexamined Patent Application Publication No. 2002-110160. As a result, it was found that when the negative electrode active material was used for a lithium ion battery, the range of the charge and discharge voltage was a wide range of 0 to 3 V relative to a lithium reference electrode. From a practical standpoint, it is desirable that the capacity be increased in a voltage range of 0 to 2 V in cases in which a negative electrode active material is commonly used. The present inventors arrived at the configuration of the present disclosure on the basis of the above-described viewpoints.

A negative electrode active material according to a first aspect of the present disclosure includes a layered compound that includes: layers each containing carbon and boron, and nitrogen or phosphorus; and calcium.

The negative electrode active material according to the first aspect has a high discharge capacity density.

In a second aspect of the present disclosure, for example, the layered compound of the negative electrode active material according to the first aspect has a layer structure, the layer structure has interlayer portions, and the calcium is present in the interlayer portions. According to the second aspect, a negative electrode active material having a higher discharge capacity can be realized.

In a third aspect of the present disclosure, for example, in the negative electrode active material according to the first or second aspect, a molar ratio of nitrogen or phosphorus to boron is less than 50%. According to the third aspect, a balance between an increase in discharge capacity density and an improvement in electrical conductivity can be achieved.

In a fourth aspect of the present disclosure, for example, the negative electrode active material according to any one of the first aspect to third aspect is denoted by composition formula (1) described below. According to the fourth aspect, a negative electrode active material having a higher discharge capacity can be realized.

CaₓB_{y-z}M_{z}C_{1-y} (1)

(in composition formula (1), M represents nitrogen or phosphorus, and x, y, and z satisfy the relationship represented by 0<x<0.2, 2x≤y≤0.5, and 0<z<0.5y)

A battery according to a fifth aspect of the present disclosure includes a negative electrode containing the negative electrode active material according to any one of the first to fourth aspects, a positive electrode, and an electrolyte.

According to the fifth aspect, a battery having a high discharge capacity can be provided.

The embodiments according to the present disclosure will be described below. The present disclosure is not limited to the embodiments described below.

### First Embodiment

A negative electrode active material according to the present embodiment is a layered compound has graphite-like layers and calcium. Calcium is supported by the graphite-like layers. The graphite-like layers each are composed of carbon and boron, and nitrogen or phosphorus.

The present inventors examined changes in the discharge capacity density of a negative electrode active material produced by forming a solid solution of graphite with calcium and boron and further including nitrogen so as to form a solid solution. As a result, the resulting negative electrode active material exhibited a higher discharge capacity density than the solid solution of graphite with only calcium and boron. The reason for this is considered to be as described below, for example.

Graphite occludes lithium into interlayer portions thereof. A lithium atom can be occluded per six carbon atoms (LiC₆). Meanwhile, a graphite-like compound (MeBC, where Me represents a metal element, B represents boron, and C represents carbon), which can occlude more metal cations into interlayer portions, can be synthesized by heat-treating a mixture of graphite, a metal, and a boron compound. For example, Mg_{0.25}B_{0.5}C_{0.5} and Ca_{0.25}B_{0.5}C_{0.5} are graphite-like compounds in which half the carbon atoms in a graphite crystal are substituted with boron atoms. In the interlayer portions of the graphite-like compound, 1.5 metal cations are present for every six atoms in total of carbon atoms and boron atoms.

The electron number of a boron atom is less than the electron number of a carbon atom by one. Consequently, when boron forms a solid solution with graphite, the electron density of the resulting graphite-like compound is lower than the electron density of graphite. When the electron density decreases, the graphite-like compound readily receives electrons from metal cations. It is conjectured that, as a result, more metal cations can be present in interlayer portions of the graphite-like compound compared with graphite.

However, a graphite-like compound such as MeBC has a disadvantage. That is, defects are generated in a π electron cloud that spreads over the graphene surface due to formation of a solid solution of graphite with boron. It is considered that the electrical conductivity of MeBC is degraded compared with graphite, which is an intrinsic conductor. In order to achieve a higher discharge capacity density, the electrical conductivity has to be improved. The electrical conductivity is improved by forming a solid solution of graphite with nitrogen or phosphorus, which are group 15 elements. A nitrogen atom or a phosphorus atom has one more valence electron than a carbon atom. Consequently, the nitrogen atom and the phosphorus atom eliminate electron defects generated due to formation of a solid solution with boron and improve the electrical conductivity of a graphite-like compound.

Considering that a decrease in electron density caused by formation of a solid solution with boron is the factor for an increase in the number of metal cations occluded in interlayer portions, it is conjectured that formation of a solid solution with nitrogen or phosphorus in an amount not canceling the effect of increasing the amount of metal cations occluded is effective. In other words, it is conjectured that formation of a solid solution with a group 15 element in an amount (number of atoms) less than the amount of boron atoms is effective for increasing the amount of metal cations occluded.

The negative electrode active material according to the present embodiment is a graphite-like compound, which may be identified by, for example, X-ray diffraction analysis (XRD analysis). The composition ratio of the negative electrode active material according to the present embodiment may be identified by inductively coupled plasma (ICP) emission spectrometry and X-ray photoelectric spectroscopy (XPS). Specifically, the composition ratio of calcium, boron, and other elements may be identified by ICP emission spectrometry. Subsequently, the composition ratio of carbon and nitrogen or the composition ratio of carbon and phosphorus may be identified by XPS.

In the negative electrode active material according to the present embodiment, the layered compound may have a layer structure. The layer structure may have interlayer portions. At this time, calcium may be present in the interlayer portions. According to such a configuration, a negative electrode active material having a higher discharge capacity can be realized.

In the negative electrode active material according to the present embodiment, a molar ratio of nitrogen or phosphorus to boron may be less than 50%. According to such a configuration, a negative electrode active material having a higher discharge capacity can be realized. There is no particular limitation regarding the lower limit of the molar ratio of nitrogen or phosphorus to boron, and the lower limit is, for example, 3%.

The molar ratio of nitrogen or phosphorus to boron can be calculated from the intensity of a spectrum obtained by X-ray photoelectric spectroscopy (XPS). Specifically, an intensity integrated value of an N1s peak present in a binding energy range of 394 to 404 eV is calculated. The value produced by dividing the intensity integrated value of the N1s peak by the nitrogen sensitivity coefficient intrinsic to an instrument is defined as “A”. The intensity integrated value of a P2p peak present in a binding energy range of 130 to 140 eV is calculated. The value produced by dividing the intensity integrated value of the P2p peak by the phosphorus sensitivity coefficient intrinsic to the instrument is defined as “B”. The intensity integrated value of a B1s peak present in a binding energy range of 184 to 194 eV is calculated. The value produced by dividing the intensity integrated value of the B1s peak by the boron sensitivity coefficient intrinsic to the instrument is defined as “C”. The molar ratio of nitrogen to boron is calculated as A/C. The molar ratio of phosphorus to boron is calculated as B/C.

The negative electrode active material according to the present embodiment may be a material denoted by composition formula (1) described below. In composition formula (1), M represents nitrogen or phosphorus, and x, y, and z satisfy the relationship represented by 0<x<0.2, 2x≤y≤0.5, and 0<z<0.5y. According to such a configuration, a negative electrode active material having a higher discharge capacity can be realized.

CaₓB_{y-z}M_{z}C_{1-y} (1)

The negative electrode active material according to the present embodiment may be produced by a method described below.

A carbon source, a boron source, a calcium source, and a nitrogen or phosphorus source are sufficiently mixed. The resulting mixture is fired in an inert atmosphere. As a result, the negative electrode active material according to the present embodiment is produced.

Regarding the carbon source, at least one selected from the group consisting of graphite materials, organic materials, and amorphous carbon materials may be used. When a graphite material is used as the carbon source, simultaneous formation of solid solutions of the graphite material with boron, nitrogen, and calcium advances. When an organic material or amorphous carbon material is used as the carbon source, graphitization of the carbon source and formation of a solid solution of graphite with each element advance at the same time.

Regarding the organic material, synthetic resins, e.g., polyvinyl alcohol, may be used. There is no particular limitation regarding the form of the synthetic resin, and examples of the form include a sheet, fibers, and particles. The organic material may be a synthetic resin in the form of particles or short fibers having a size of 1 to 100 μm in consideration of, for example, processing after firing.

Regarding the amorphous carbon material, soft carbon, e.g., petroleum coke and coal coke, may be used. There is no particular limitation regarding the form of the soft carbon, and examples of the form include a sheet, fibers, and particles. The amorphous carbon material may be soft carbon in the form of particles or short fibers having a size of 1 to 100 μm in consideration of processing after firing.

Regarding the boron source, boron, boric acid, calcium boride, and the like may be used. Diborides, e.g., aluminum diboride and magnesium diboride, may also be used as the boron source.

Regarding the nitrogen source, ammonia, nitrogen, cyanides, carbon nitride, nitrogen-containing organic materials, and the like may be used. The carbon nitride may be graphitic carbon nitride. Examples of nitrogen-containing organic materials include porphyrin, phthalocyanine, pyridine, phenanthroline, and derivatives thereof.

Regarding the calcium source, calcium metal, calcium hydride, calcium hydroxide, calcium carbide, calcium carbonate, and the like may be used.

Regarding the phosphorus source, phosphorus, boron phosphide, phosphoric acid, calcium phosphate, and the like may be used.

The firing temperature is, for example, 1,000° C. to 2,000° C. The firing atmosphere is, for example, an inert atmosphere. Regarding the inert atmosphere, inert gasses, e.g., nitrogen gas, argon gas, helium gas, and neon gas, may be used. The inert atmosphere may be nitrogen gas from the viewpoint of cost. Carbonization of a raw material is advanced by firing at a temperature lower than 1,000° C. because elements other than carbon are vaporized from the raw material used as the carbon source. Graphitization of carbon is advanced by firing at 1,000° C. to 2,000° C. Reactions between the carbon source and each of the boron source, the nitrogen source, and the calcium source occur with graphitization of carbon. As a result, formation of a solid solution of a graphite crystal with boron and nitrogen advances while calcium enters interlayer portions of graphite so as to form a solid solution.

The ratio of constituent elements in the negative electrode active material can be adjusted by appropriately selecting the type of raw materials, the mixing ratio of the raw materials, the firing condition of the raw material mixture, the reprocessing condition after firing, and the like. The type of raw materials refers to the type of the carbon source, the type of the boron source, the type of the calcium source, the type of the nitrogen source, and the type of the phosphorus source. The mixing ratio of the raw materials refers to the mixing ratio of each of the carbon source, the boron source, the calcium source, and the nitrogen source or the phosphorus source. Examples of reprocessing after firing include acid washing and additional heat treatment.

As described above, the negative electrode active material according to the present embodiment may be produced through a step of mixing the raw materials and a step of firing the resulting raw material mixture in an inert atmosphere. In the step of mixing the raw materials, the carbon source, the boron source, the calcium source, and the nitrogen source or the phosphorus source are mixed.

### Second Embodiment

A second embodiment will be described below. The same explanations as those in the first embodiment will be omitted appropriately.

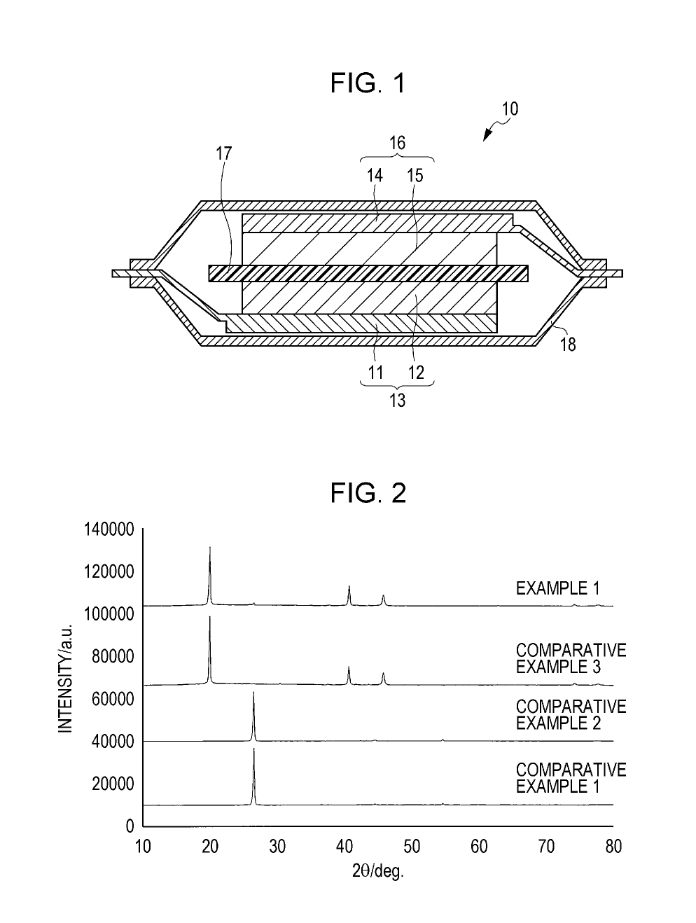

As shown in FIG. 1, a battery 10 according to the present embodiment includes a negative electrode 13, a positive electrode 16, a separator 17, and an outer jacket 18. The negative electrode 13 includes a negative electrode collector 11 and a negative electrode active material layer 12 (negative electrode mix layer). The negative electrode active material layer 12 is disposed on the negative electrode collector 11. The positive electrode 16 includes a positive electrode collector 14 and a positive electrode active material layer 15 (positive electrode mix layer). The positive electrode active material layer 15 is disposed on the positive electrode collector 14. The separator 17 is arranged between the negative electrode 13 and the positive electrode 16. The negative electrode 13 and the positive electrode 16 are opposite to each other with the separator 17 interposed therebetween. The negative electrode 13, the positive electrode 16, and the separator 17 are accommodated in the outer jacket 18.

The battery 10 is, for example, a nonaqueous electrolyte secondary battery or an all-solid secondary battery. The battery 10 is typically a lithium ion secondary battery.

The negative electrode active material layer 12 contains the negative electrode active material described in the first embodiment. The negative electrode active material layer 12 may contain a second negative electrode active material, a conductive auxiliary agent, an ionic conductor, a binder, and the like, as necessary. The second negative electrode active material is a negative electrode active material having a composition different from the composition of the negative electrode active material described in the first embodiment and is a material that can occlude and release lithium ions.

The negative electrode active material layer 12 may contain the negative electrode active material described in the first embodiment as a primary component. “Primary component” refers to a component, the content of which is the largest on a mass ratio basis. The negative electrode active material layer 12 may contain the negative electrode active material described in the first embodiment in a mass ratio of 50% or more relative to the total negative electrode active material layer 12, or may contain in 70% or more. According to such a configuration, the battery 10 having a higher discharge capacity density can be realized.

The negative electrode active material layer 12 contains the negative electrode active material as a primary component and may further contain incidental impurities. Examples of incidental impurities include starting raw materials used for synthesizing the negative electrode active material, by-products generated when the negative electrode active material is synthesized, and decomposition products thereof. The negative electrode active material layer 12 may contain the negative electrode active material described in the first embodiment in a mass ratio of 100% relative to the total negative electrode active material layer 12 except for incidental impurities.

The conductive auxiliary agent and the ionic conductor are used to reduce the resistance of the negative electrode 13. Regarding the conductive auxiliary agent, carbon materials (carbon conductive auxiliary agent), e.g., carbon black, graphite, acetylene black, carbon nanotube, carbon nanofiber, graphene, fullerene, and graphite oxide, and conductive polymers, e.g., polyanilines, polypyrroles, and polythiophenes, may be used. Regarding the ionic conductor, gel electrolytes, e.g., polymethyl methacrylate, organic solid electrolytes, e.g., polyethylene oxide, and inorganic solid electrolytes, e.g., Li₇La₃Zr₂O₁₂, may be used.

The binder is used to improve the binding properties of materials constituting the negative electrode 13. Regarding the binder, polymers, e.g., polyvinylidene fluorides, vinylidene fluoride-hexafluoropropylene copolymers, vinylidene fluoride-tetrafluoroethylene copolymers, polytetrafluoroethylenes, carboxymethyl cellulose, polyacrylic acids, styrene-butadiene copolymer rubbers, polypropylenes, polyethylenes, and polyimides, may be used.

Regarding the negative electrode collector 11, a sheet or film that is formed of a metal material, e.g., stainless steel, nickel, copper, or an alloy thereof, may be used. The sheet or film may be porous or nonporous. Regarding the sheet or film, metal foil, metal mesh, or the like is used. The surface of the negative electrode collector 11 may be coated with a carbon material, e.g., carbon, serving as a conductive auxiliary material. In this case, the resistance value may be reduced, a catalytic effect may be provided, and the bonding force between the negative electrode active material layer 12 and the negative electrode collector 11 may be enhanced by chemically or physically bonding the negative electrode active material layer 12 to the negative electrode collector 11.

The positive electrode active material layer 15 contains a positive electrode active material that can occlude and release lithium ions. The positive electrode active material layer 15 may contain a conductive auxiliary agent, an ionic conductor, a binder, and the like, as necessary. Regarding the conductive auxiliary agent, the ionic conductor, and the binder, the same materials as the materials usable for the negative electrode active material layer 12 can be used for the positive electrode active material layer 15.

Regarding the positive electrode active material, lithium-containing transition metal oxides, transition metal fluorides, polyanionic materials, fluorinated polyanionic materials, transition metal sulfides, and the like may be used. The positive electrode active material may be a lithium-containing transition metal oxide because of an inexpensive production cost and a high average discharge voltage.

Regarding the positive electrode collector 14, a sheet or film that is formed of a metal material, e.g., aluminum, stainless steel, titanium, or an alloy thereof, may be used. Aluminum or an alloy thereof is suitable for a material for forming the positive electrode collector 14 because of a low price and being readily made into a thin film. The sheet or film may be porous or nonporous. Regarding the sheet or film, metal foil, metal mesh, or the like is used. The surface of the positive electrode collector 14 may be coated with a carbon material, e.g., carbon, serving as a conductive auxiliary material. In this case, the resistance value may be reduced, a catalytic effect may be provided, and the bonding force between the positive electrode active material layer 15 and the positive electrode collector 14 may be enhanced by chemically or physically bonding the positive electrode active material layer 15 to the positive electrode collector 14.

The battery 10 further includes an electrolyte. The electrolyte may be a nonaqueous electrolyte. Regarding the electrolyte, an electrolytic solution containing a lithium salt and a nonaqueous solvent, a gel electrolyte, a solid electrolyte, and the like may be used. When the electrolyte is liquid, each of the negative electrode 13, the positive electrode 16, and the separator 17 is impregnated with the electrolyte. When the electrolyte is solid, the separator 17 may be composed of the electrolyte. A solid electrolyte may be included in the negative electrode 13 or included in the positive electrode 16.

Regarding the lithium salt, lithium hexafluorophosphate (LiPF₆), lithium tetrafluoroborate (LiBF₄), lithium perchlorate (LiClO₄), lithium bistrifluoromethylsulfonylimide (LiN(SO₂CF₃)₂), lithium bisperfluoroethylsulfonylimide (LiN(SO₂C₂F₅)₂), lithium bisfluoromethylsulfonylimide (LiN(SO₂F)₂), LiAsF_{6,} LiCF₃SO₃, lithium difluoro(oxalato)borate, and the like may be used. One electrolyte salt selected from these lithium salts may be used, or at least two types may be used in combination. The lithium salt may be LiPF₆ from the viewpoint of safety, thermal stability, and ionic conductivity of the battery 10.

Regarding the nonaqueous solvent, a cyclic carbonic acid ester, a chain carbonic acid ester, an ester, a cyclic ether, a chain ether, a nitrile, an amide, and the like may be used. One solvent selected from these solvents may be used, or at least two types may be used in combination.

Regarding the cyclic carbonic acid ester, ethylene carbonate, propylene carbonate, butylene carbonate, and the like may be used. In these compounds, some or all hydrogen atoms may be substituted with fluorine atoms. Trifluoropropylene carbonate, fluoroethyl carbonate, and the like may be used as a fluorine-substituted cyclic carbonic acid ester.

Regarding the chain carbonic acid ester, dimethyl carbonate, ethyl methyl carbonate, diethyl carbonate, methyl propyl carbonate, ethyl propyl carbonate, methyl isopropyl carbonate, and the like may be used. In these compounds, some or all hydrogen atoms may be substituted with fluorine atoms.

Regarding the ester, methyl acetate, ethyl acetate, propyl acetate, methyl propionate, ethyl propionate, γ-butyrolactone, and the like may be used.

Regarding the cyclic ether, 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineole, crown ethers, and the like may be used.

Regarding the chain ether, 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, tetraethylene glycol dimethyl ether, and the like may be used.

Acetonitrile and the like may be used as the nitrile.

Dimethylformamide and the like may be used as the amide.

An organic polymer solid electrolyte, an oxide solid electrolyte, a sulfide solid electrolyte, and the like may be used as the solid electrolyte.

A compound of a polymer and a lithium salt may be used as the organic polymer solid electrolyte. The polymer may has an ethylene oxide structure. When the polymer has an ethylene oxide structure, the organic polymer solid electrolyte can contain a large amount of lithium salt and, thereby, ionic conductivity of the organic polymer solid electrolyte is enhanced.

Regarding the oxide solid electrolyte, NASICON-type solid electrolytes represented by LiTi₂(PO₄)₃ and element-substituted compounds thereof, (LaLi)TiO₃-based perovskite solid electrolytes, LaSiCON-type solid electrolyte represented by Li₁₄ZnGe₄O₁₆, Li₄SiO₄, LiGeO₄, and element-substituted compounds thereof, garnet-type solid electrolytes represented by Li₇La₃Zr₂O₁₂ and element-substituted compounds thereof, Li₃N and H-substituted compounds thereof, Li₃PO₄ and N-substituted compounds thereof, and the like may be used.

Regarding the sulfide solid electrolyte, Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, and the like may be used. LiX (X: F, Cl, Br, or I), MOₚ, Li_{q}MOₚ (M: P, Si, Ge, B, Al, Ga, or In) (p, q: natural number), and the like may be added to these sulfide materials.

The sulfide solid electrolyte has high processability and high ionic conductivity. Consequently, the battery 10 having a higher energy density can be realized by using the sulfide solid electrolyte as the solid electrolyte. Among sulfide solid electrolytes, Li₂S—P2S₅ has high electrochemical stability and high ionic conductivity. The battery 10 having a higher energy density can be realized by using Li₂S—P₂S₅ as the solid electrolyte.

There is no particular limitation regarding the shape of the battery 10. Various shapes of coin type, cylinder type, rectangular type, sheet type, button type, flat type, layered type, and the like may be adopted as the shape of the battery 10.

The battery 10 is not limited to the lithium secondary battery and may be other batteries.

### EXAMPLES

Some instances will be described below as examples, but the present disclosure is not limited to the following examples.

### Example 1

### Production of Negative Electrode Active Material

A graphite powder having an average particle diameter of 20 μm, a calcium boride powder, a calcium carbide powder, and a graphitic carbon nitride (g-C₃N₄) powder were ground and mixed by using an agate mortar so as to produce a raw material mixture. The amount of the calcium boride powder was 62.4% relative to the graphite powder on a mass basis. The amount of the calcium carbide powder was 76.5% relative to the graphite powder on a mass basis. The amount of the graphitic carbon nitride powder was 109.8% relative to the graphite powder on a mass basis.

The raw material mixture was put into a firing furnace in an Ar atmosphere (Ar gas flow rate of 1 L/min), the temperature inside the firing furnace was increased from room temperature at a rate of 5° C./min so as to reach 1,800° C., and the temperature was maintained at 1,800° C. for 5 hours. Thereafter, heating was stopped, and a fired product was cooled naturally and taken out of the firing furnace. The fired product was ground in an agate mortar so as to produce a powder of a negative electrode active material of example 1.

### Production of Test Electrode

The negative electrode active material of example 1, acetylene black serving as a conductive auxiliary agent, and polyvinylidene fluoride serving as a binder were sufficiently mixed by using an agate mortar. As a result, a negative electrode mix was produced. The mass ratio of the negative electrode active material to acetylene black to polyvinylidene fluoride was 7:2:1. The negative electrode mix was dispersed into an NMP solvent so as to produce a slurry. A Cu collector was coated with the slurry by using a coater. A coating film on the Cu collector was dried so as to produce an electrode plate. The electrode plate was rolled by a rolling mill and, thereafter, was stamped into a 20 mm square shape. A lead terminal was attached to the electrode plate having a square shape so as to produce a test electrode of example 1.

### Production of Evaluation Cell.

A lithium secondary battery (evaluation cell) was produced by using the test electrode of example 1, a lithium metal counter electrode, and a lithium metal reference electrode in a method described below. Preparation of the electrolytic solution and production of the evaluation cell were performed in a glove box in an Ar atmosphere having a dew point of −60° C. or lower and an oxygen value of 1 ppm or less.

A mixed solvent was produced by mixing ethylene carbonate, ethyl methyl carbonate, and dimethyl carbonate in a volume ratio of 5:70:25. Lithium hexafluorophosphate (LiPF₆) was dissolved into the resulting mixed solvent so as to produce an electrolytic solution having a concentration of 1.4 mol/liter. Lithium metal foil was pressure-bonded to a 20 mm square nickel mesh so as to produce a counter electrode. A polyethylene microporous film separator was impregnated with the electrolytic solution. The separator was arranged between the test electrode and the counter electrode so as to oppose the test electrode to the counter electrode. The test electrode and the counter electrode were accommodated in an outer jacket, and the outer jacket was sealed. In this manner, the evaluation cell of example 1 was produced.

### Example 2

A negative electrode active material, a test electrode, and an evaluation cell of example 2 were produced in the same manner as example 1 except that the ratio of the raw materials were changed. In example 2, the amount of the calcium boride powder was 48.5% relative to the graphite powder on a mass basis. The amount of the calcium carbide powder was 59.5% relative to the graphite powder on a mass basis. The amount of the graphitic carbon nitride powder was 28.5% relative to the graphite powder on a mass basis.

### Example 3

A negative electrode active material, a test electrode, and an evaluation cell of example 3 were produced in the same manner as example 1 except that the ratio of the raw materials were changed. In example 3, the amount of the calcium boride powder was 58.2% relative to the graphite powder on a mass basis. The amount of the calcium carbide powder was 71.3% relative to the graphite powder on a mass basis. The amount of the graphitic carbon nitride powder was 85.3% relative to the graphite powder on a mass basis.

### Example 4

A negative electrode active material, a test electrode, and an evaluation cell of example 4 were produced in the same manner as example 1 except that a graphite powder having an average particle diameter of 1 μm was used as the carbon source and the ratio of the raw materials were changed. In example 4, the amount of the calcium boride powder was 58.2% relative to the graphite powder on a mass basis. The amount of the calcium carbide powder was 71.3% relative to the graphite powder on a mass basis. The amount of the graphitic carbon nitride powder was 85.3% relative to the graphite powder on a mass basis.

### Comparative Example 1

A graphite powder having an average particle diameter of 20 μm was used as a negative electrode active material of comparative example 2.

A graphite powder having an average particle diameter of 20 μm and polyvinylidene fluoride serving as a binder were sufficiently mixed by using an agate mortar. The mass ratio of the graphite powder to polyvinylidene fluoride was 9:1. The resulting mixture was dispersed into an NMP solvent so as to produce a slurry. A Cu collector was coated with the slurry by using a coater. A coating film on the Cu collector was dried so as to produce an electrode plate. The electrode plate was rolled by a rolling mill and, thereafter, was stamped into a 20 mm square shape. A lead terminal was attached to the electrode plate having a square shape so as to produce a test electrode of comparative example 1. An evaluation cell of comparative example 1 was produced by using the test electrode of comparative example 1 in the same manner as example 1.

### Comparative Example 2

A graphite powder having an average particle diameter of 20 μm and a boron powder were ground and mixed by using an agate mortar so as to produce a raw material mixture. The amount of the boron powder was 27.8% relative to the graphite powder on a mass basis.

The raw material mixture was put into a firing furnace in an Ar atmosphere (Ar gas flow rate of 1 L/min), the temperature inside the firing furnace was increased from room temperature at a rate of 5° C./min so as to reach 1,800° C., and the temperature was maintained at 1,800° C. for 5 hours. Thereafter, heating was stopped, and a fired product was cooled naturally and taken out of the firing furnace. The fired product was ground in an agate mortar so as to produce a powder of a negative electrode active material (graphite-like compound) of comparative example 2.

The negative electrode active material of comparative example 2 and polyvinylidene fluoride serving as a binder were sufficiently mixed by using an agate mortar. The mass ratio of the graphite powder to polyvinylidene fluoride was 9:1. The resulting mixture was dispersed into an NMP solvent so as to produce a slurry. A Cu collector was coated with the slurry by using a coater. A coating film on the Cu collector was dried so as to produce an electrode plate. The electrode plate was rolled by a rolling mill and, thereafter, was stamped into a 20 mm square shape. A lead terminal was attached to the electrode plate having a square shape so as to produce a test electrode of comparative example 2. An evaluation cell of comparative example 2 was produced by using the test electrode of comparative example 2 in the same manner as example 1.

### Comparative Example 3

A graphite powder having an average particle diameter of 20 μm, a calcium boride powder, and a calcium carbide powder were ground and mixed by using an agate mortar so as to produce a raw material mixture. The amount of the calcium boride powder was 62.4% relative to the graphite powder on a mass basis. The amount of the calcium carbide powder was 91.5% relative to the graphite powder on a mass basis.

The raw material mixture was put into a firing furnace in an Ar atmosphere (Ar gas flow rate of 1 L/min), the temperature inside the firing furnace was increased from room temperature at a rate of 5° C./min so as to reach 1,500° C., and the temperature was maintained at 1,500° C. for 5 hours. Thereafter, heating was stopped, and a fired product was cooled naturally and taken out of the firing furnace. The fired product was ground in an agate mortar so as to produce a powder of a negative electrode active material of comparative example 3.

A test electrode and an evaluation cell of comparative example 3 were produced by using the negative electrode active material of comparative example 3 in the same manner as example 1.

### Analysis of Negative Electrode Active Material

The negative electrode active materials of example 1 and comparative examples 1 to 3 were subjected to powder X-ray diffractometry by using a benchtop X-ray diffraction instrument (MiniFlex 300/600 produced by Rigaku Corporation). The results are shown in FIG. 2. The negative electrode active material of example 1 showed a diffraction pattern close to the diffraction pattern of the negative electrode active material (CaBC) of comparative example 3. Specifically, peaks of the diffraction pattern of example 1 were present at 2θ=about 20° and 2θ=about 40°. The positions of these peaks were in accord with the position of a peak attributed to the (100) face of CaBC that was a layered compound having an interlayer distance of about 4.5 Å or the position of peaks attributed to the (200) face. This indicates that the negative electrode active material of example 1 had a layer structure. Further, the interlayer distance of the negative electrode active material of example 1 was more than the interlayer distance (3.35 Å) of the graphite of comparative example 1. This indicates that calcium was present in interlayer portions of the negative electrode active material of example 1.

The composition ratio of calcium, boron, and other elements in each of examples 1 to 4 and comparative examples 1 to 3 was examined by using an inductively coupled plasma emission spectrometer (CIROS-120 produced by SPECTRO).

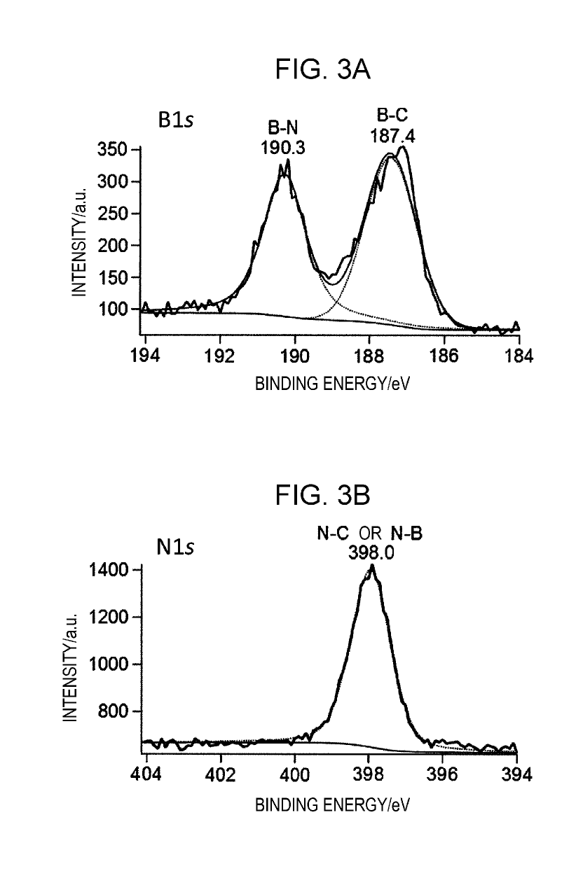

An XPS spectrum of the negative electrode active material of each of examples 1 to 4 was obtained by using an X-ray photoelectric spectroscopy instrument (VersaProbe produced by ULVAC-PHI, Inc.). The results obtained in example 1 are shown in FIG. 3A and FIG. 3B. As shown in FIG. 3A, peaks attributed to the B1s orbital appeared at a position of the binding energy of each of 187.4 eV (B-C bond) and 190.3 eV (B-N bond). As shown in FIG. 3B, a peak attributed to the N1s orbital appeared at 398.0 eV. The molar ratio of nitrogen to boron (N/B) was calculated by the above-described method. The composition of the negative electrode active material of each of examples 1 to 4 and comparative examples 1 to 3 was calculated from the results of ICP and XPS. The results are shown in Table.

### Charge Discharge Test

The evaluation cell of each of examples 1 to 4 and comparative examples 1 to 3 was subjected to a charge discharge test, and the charge discharge characteristics were evaluated. The charge discharge test was performed in a thermostatic chamber at 25° C. In the charge discharge test, the evaluation cell was charged, and after suspension for 20 minutes, the evaluation cell was discharged. Charging was performed at a constant current of 5 mA per square centimeter of the test electrode until the potential difference between the test electrode and the reference electrode reached 0 V. Subsequently, discharging was performed at a constant current of 5 mA per square centimeter of the test electrode until the potential difference between the test electrode and the reference electrode reached 2 V. The measured discharge capacity is shown in Table. The discharge capacity shown in Table is a value converted to a value per gram of the negative electrode active material.

TABLE

| | | Discharge capacity |
|---|---|---|
| | Composition | (mAh/g) |
| Example 1 | Ca_{0.09}B_{0.14}N_{0.06}C_{0.80} | 556 |
| Example 2 | Ca_{0.08}B_{0.15}N_{0.03}C_{0.82} | 351 |
| Example 3 | Ca_{0.10}B_{0.21}N_{0.05}C_{0.74} | 372 |
| Example 4 | Ca_{0.13}B_{0.22}N_{0.06}C_{0.72} | 427 |
| Comparative example 1 | C (graphite) | 343 |
| Comparative example 2 | B_{0.14}C_{0.86} | 240 |
| Comparative example 3 | Ca_{0.12}B_{0.23}C_{0.77} | 291 |

As shown in Table, the discharge capacity increased when the graphite formed a solid solution with calcium, boron, and nitrogen (examples 1 to 4). As described above, the reason for this is conjectured that electrical conductivity was improved by forming a solid solution of graphite with calcium and boron and further including nitrogen so as to form a solid solution.

The discharge capacity of comparative example 2 (BC) was smaller than the discharge capacity of comparative example 1 (graphite). The reason for this is conjectured that electrochemically inert boron carbide B4C was generated during synthesis of the negative electrode active material of comparative example 2. The discharge capacity of comparative example 3 (CaBC) was smaller than the discharge capacity of comparative example 1 (graphite). The reason for this is conjectured that charging and discharging were performed while some amount of calcium was present in interlayer portions of the layer structure composed of boron and carbon.

In the negative electrode active materials of examples 1 to 4, the molar ratios of nitrogen to boron (N/B) were 0.444, 0.195, 0.230, and 0.272, respectively. All the ratios (N/B) were less than 0.5.

It is considered that, in the negative electrode active material of each of examples 1 to 4, some calcium atoms that are included in interlayer portions of the layer structure so as to form a solid solution are dissolved into the electrolytic solution in accordance with charging and discharging, and the rest remains in interlayer portions. Even when calcium atoms are present in interlayer portions, not all sites that are involved in charging and discharging are occupied by calcium atoms, and vacant sites are involved in insertion and release of lithium atoms.

What is claimed is:

1. A negative electrode active material comprising a layered compound that includes:
a plurality of layers each containing carbon and boron and further containing nitrogen or phosphorus; and
calcium located between the plurality of layers.

2. The negative electrode active material according to claim 1,
wherein a molar ratio of the nitrogen or the phosphorus to the boron is less than 50%.

3. The negative electrode active material according to claim 1,
wherein the layered compound is represented by a formula CaₓB_{y-z}M_{z}C_{1-y}, where M is the nitrogen or the phosphorus; and 0<x<0.2, 2x≤y≤0.5, and 0<z<0.5y.

4. A battery comprising:
a negative electrode containing the negative electrode active material according to claim 1;
a positive electrode; and
an electrolyte.
